(19) United States
(12) Patent Application Publication
(10) Pub. No.: US 2024/0334008 A1
(43) Pub. Date: Oct. 3, 2024

(54) LIVENESS DETECTION

(71) Applicants: Securiport LLC, Reston, VA (US); University of Notre Dame du Lac, South Bend, IN (US)

(72) Inventors: Jeremy Speth, South Bend, IN (US); Nathan Carpenter, Reston, VA (US); Nathan Vance, South Bend, IN (US); Lu Niu, South Bend, IN (US); Siamul Khan, South Bend, IN (US); Adam Czajka, South Bend, IN (US); Patrick Flynn, South Bend, IN (US)

(21) Appl. No.: 18/625,685

(22) Filed: Apr. 3, 2024

Related U.S. Application Data
(60) Provisional application No. 63/456,795, filed on Apr. 3, 2023.

(51) Int. Cl. H04N 21/4415; G06V 10/25; G06V 10/80; G06V 40/10; G06V 40/40; H04N 21/422

(52) U.S. Cl. CPC H04N 21/4415; G06V 10/25; G06V 10/80; G06V 40/10; G06V 40/40; H04N 21/42201

(57) ABSTRACT

Liveness detection includes systems, devices, methods, and non-transitory instructions for detecting liveness of a subject from a media stream, including capturing a media stream of the subject, the media stream including a sequence of frames, processing each frame of the media stream to track one or more biometrics, and determining whether the subject in the media stream is live based on the one or more biometrics detected in the media steam.

### PRIORITY INFORMATION

This application claims the benefit of U.S. Provisional Patent Application No. 63/456,795 filed on Apr. 3, 2023, which is hereby incorporated by reference in its entirety.

### FIELD OF THE INVENTION

The embodiments of the present invention generally relate to use of biometrics, and more particularly, to media-based liveness detection and remote physiological monitoring using one or more modalities (e.g., pulse).

### DISCUSSION OF THE RELATED ART

Liveness detection is the task of predicting whether the portrayed subject in a digital media (typically image or video steam) is authentic. Any sample other than the original subject where the identity and actions remain unaltered is considered an attack. Attacks are roughly divided into two different categories of digital and physical attacks.

Perhaps the most well-known type of digital attack is a DeepFake where the identity and/or actions of the portrayed person are changed from the original sample. Recently, DeepFakes have become increasingly difficult to detect due to rapid research advances in generative modeling. Physical attacks are typically introduced during presentation to the sensor (e.g., wearing a face mask with a different identity at a checkpoint, such as a border checkpoint). Another example of a physical attack is the displaying a picture or video stream illustrating a different identity at a border checkpoint or kiosk. Both digital and physical attacks alter the visual appearance from a “live” sample. The visual changes depend on the type of attack.

Accordingly, the inventors have developed systems, devices, methods, and non-transitory computer-readable instructions that enable accurate liveness detection from a video stream.

### SUMMARY OF THE INVENTION

Accordingly, the embodiments of the present invention are directed to liveness detection that substantially obviates one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the liveness detection includes systems, devices, methods, and non-transitory instructions (stored in a memory, and executed by a processor) for tracking and/or evaluating one or more parameters to detect one or more anomalies in a media/video stream and determining the likelihood of liveness therefrom.

In connection with any of the various embodiments, the liveness detection includes systems, devices, methods, and non-transitory instructions for detecting liveness of a subject from a media stream, comprising capturing a media stream of the subject, the media stream including a sequence of frames, processing each frame of the media stream to track one or more biometrics of the subject, and determining whether the subject in the media stream is live based on the one or more biometrics detected in the media steam.

In connection with any of the various embodiments, the media stream includes one or more of a visible-light video stream, a near-infrared video stream, a longwave-infrared video stream, a thermal video stream, and an audio stream of the subject.

In connection with any of the various embodiments, the one or more biometrics includes two or more of pulse rate, eye gaze, eye blink rate, pupil diameter, face temperature, speech, respiration rate, and micro-expressions.

In connection with any of the various embodiments, the one or more biometrics includes pulse rate and respiration rate.

In connection with any of the various embodiments, each frame of the media stream is cropped to encapsulate a region of interest that includes one or more of a face, facial cheek, forehead, eye, eye pupil, chest, or hand.

In connection with any of the various embodiments, the region of interest includes two or more body parts.

In connection with any of the various embodiments, combining at least two of a visible-light video stream, a near-infrared video stream, and a thermal video stream into a fused video stream.

In connection with any of the various embodiments, the visible-light video stream, the near-infrared video stream, and/or the thermal video stream are combined according to a synchronization device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a system for liveness detection using pulse waveform estimation.

FIG. 2 illustrates an analysis of images collected in different spectra.

FIG. 3 illustrates changes observed in a subject's pulse rate.

FIG. 4 illustrates a correlation between inferred and ground truth rPPG signals at each facial region.

FIG. 5 illustrates that a facial region can be divided into regions of interest.

FIG. 6 illustrates detection of circles fitting an iris and a pupil.

FIG. 7 illustrates a computer-implemented method for liveness detection.

FIG. 8 illustrates another system for liveness detection.

### DETAILED DESCRIPTION

Reference will now be made in detail to the embodiments of the present invention, examples of which are illustrated in the accompanying drawings. Wherever possible, like reference numbers will be used for like elements.

In general, biometrics may be used to track vital signs that provide indicators about a subject's physical state that may be used in a variety of ways. As an example, for border security or health monitoring, vital signs may be used to screen for health risks (e.g., temperature). While sensing temperature is a well-developed technology, collecting other useful and accurate vital signs such as pulse rate (i.e., heart rate or heart beats per minute) or pulse waveform has required physical devices to be attached to the subject. The desire to perform biometric measurement without physical contact has produced some video-based techniques.

Performing reliable pulse rate or pulse waveform estimation from a camera sensor is more difficult than contact plethysmography for several reasons. The change in reflected light from the skin's surface, because of light absorption of blood, is very minor compared to those caused by changes in illumination. Even in settings with ambient lighting, the subject's movements drastically change the reflected light and can overpower the pulse signal.

In the various embodiments, the inventors have developed systems, devices, methods, and non-transitory computer-readable instructions that enable accurate liveness detection from a video stream, and determine the likelihood of liveness therefrom.

Embodiments of user interfaces and associated methods for using a device are described. It should be understood, however, that the user interfaces and associated methods can be applied to numerous device types, such as a portable communication device such as a tablet or mobile phone or AR/VR glasses. The portable communication device can support a variety of applications, such as wired or wireless communications. The various applications that can be executed on the device can use at least one common physical user-interface device, such as a touchscreen. One or more functions of the touchscreen as well as corresponding information displayed on the device can be adjusted and/or varied from one application to another and/or within a respective application. In this way, a common physical architecture of the device can support a variety of applications with user interfaces that are intuitive and transparent.

The embodiments of the present invention provide, inter alia, systems, devices, methods, and non-transitory computer-readable instructions to measure one or more biometrics, including heart-rate and pulse waveform, in a video stream. In the various embodiments, the systems, devices, methods, and instructions collect, process, and analyze video taken in one or more modalities (e.g., visible light, near infrared, longwave infrared, thermal, pulse, gaze, blinking, pupillometry, face temperature, and micro-expressions, etc.) to detect liveness in a video steam.

For example, the pulse waveform for the subject's heartbeat may be used as a biometric input to establish features of the physical state of the subject and how they change over a period of observation (e.g., while at a border during questioning or other activity). Remote photoplethysmography (rPPG) is the monitoring of blood volume pulse from a camera at a distance. Using rPPG, blood volume pulse from video at a distance from the skin's surface may be detected. The disclosure of U.S. application Ser. No. 17/591,929, entitled “VIDEO BASED DETECTION OF PULSE WAVEFORM”, filed 3 Feb. 2022, is hereby incorporated by reference, in its entirety.

In various embodiments, changes to the subject's eye gaze, eye blink rate, pupil diameter, speech, face temperature, respiration rate, and micro-expressions are additionally, or alternatively, used to determine liveness in a video stream. For example, pupil diameter varies with changes in lighting. In another example, eye movements, gestures, and posture also can be used to detect liveness. In yet another example, pulse rates of different body parts (e.g., hand and forehead) can be compared to determine liveness.

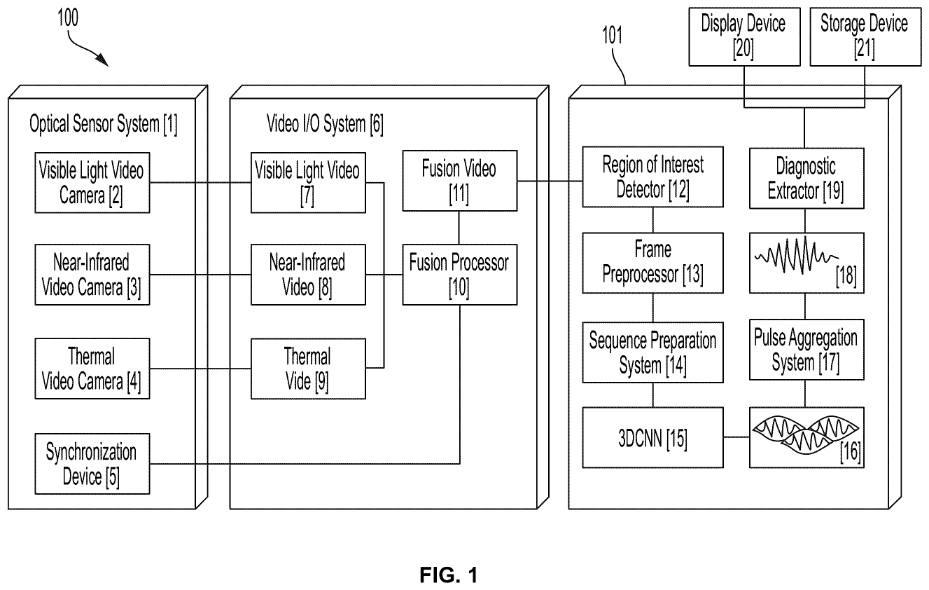

FIG. 1 illustrates a system 100 for liveness detection using pulse waveform estimation. System 100 includes optical sensor system 1, video 1/O system 6, and video processing system 101.

Optical sensor system 1 includes one or more camera sensors, each respective camera sensor configured to capture a video stream including a sequence of frames. For example, optical sensor system 1 may include a visible-light camera 2, a near-infrared camera 3, a thermal camera 4, or any combination thereof. In the event that multiple camera sensors are utilized (e.g., single modality or multiple modality), the resulting multiple video streams may be synchronized according to synchronization device 5. Alternatively, or additionally, one or more video analysis techniques may be utilized to synchronize the video streams. Although a visible-light camera 2, a near-infrared camera 3, and a thermal camera 4 are enumerated, other media devices can be used, such as a microphone or speech recorder.

Video I/O system 6 receives the captured one or more video streams. For example, video 1/O system 6 is configured to receive raw visible-light video stream 7, near-infrared video stream 8 (or longwave-infrared video stream), and thermal video stream 9 from optical sensor system 1. Here, the received video streams may be stored according to known digital format(s). In the event that multiple video streams are received (e.g., single modality or multiple modality), fusion processor 10 is configured to combine the received video streams. For example, fusion processor 10 may combine visible-light video stream 7, near-infrared video stream 8, and/or thermal video stream 9 into a fused video stream 11. Here, the respective streams may be synchronized according to the output (e.g., a clock signal) from synchronization device 5.

At video processing system 101, region of interest detector 12 detects (i.e., spatially locate) one or more spatial regions of interest (ROI) within each video frame. The ROI may be a face, another body part (e.g., a hand, an arm, a foot, a neck, forehead, facial cheek, etc.) or any combination of body parts. Initially, region of interest detector 12 determines one or more coarse spatial ROIs within each video frame. Region of interest detector 12 is robust to strong facial occlusions from face masks and other head garments. Subsequently, frame preprocessor 13 crops the frame to encapsulate the one or more ROI. In some embodiments, the cropping includes each frame being downsized by bi-cubic interpolation to reduce the number of image pixels to be processed. Alternatively, or additionally, the cropped frame may be further resized to a smaller image.

Sequence preparation system 14 aggregates batches of ordered sequences or subsequences of frames from frame processer 13 to be processed. Next, 3-Dimensional Convolutional Neural Network (3DCNN) 15 receives the sequence or subsequence of frames from the sequence preparation system 14. 3DCNN 15 processes the sequence or subsequence of frames, by a 3-dimensional convolutional neural network, to determine the spatial and temporal dimensions of each frame of the sequence or subsequence of frames and to produce a pulse waveform point for each frame of the sequence of frames. 3DCNN 15 applies a series of 3-dimensional convolution, averaging, pooling, and nonlinearities to produce a 1-dimensional signal approximating the pulse waveform 16 for the input sequence or subsequences.

In some configurations, pulse aggregation system 17 combines any number of pulse waveforms 16 from the sequences or subsequences of frames into an aggregated pulse waveform 18 to represent the entire video stream. Diagnostic extractor 19 is configured to compute the heart rate and the heart rate variability from the aggregated pulse waveform 18. To identify heart rate variability, the calculated heart rate of various subsequences may be compared. Display unit 20 receives real-time or near real-time updates from diagnostic extractor 19 and displays aggregated pulse waveform 18, heart rate, and heart rate variability to an operator. Storage Unit 21 is configured to store aggregated pulse waveform 18, heart rate, and heart rate variability associated with the subject.

In some embodiments, pulse rates of different body parts (e.g., hand and forehead) can be compared to determine liveness. In this example, the pulse rates of the respective body parts should match, and may include an expected time offset (e.g., 70-80 ms) between body parts.

Additionally, or alternatively, the sequence of frames may be partitioned into a partially overlapping sub-sequences within the sequence preparation system 14, wherein a first subsequence of frames overlaps with a second subsequence of frames. The overlap in frames between subsequences prevents edge effects. Here, pulse aggregation system 17 may apply a Hann function to each subsequence, and the overlapping subsequences added to generate aggregated pulse waveform 18 with the same number of samples as frames in the original video stream. In some configurations, each subsequence is individually passed to the 3DCNN 15, which performs a series of operations to produce a pulse waveform for each subsequence 16. Each pulse waveform output from the 3DCNN 15 is a time series with a real value for each video frame. Since each subsequence is processed by the 3DCNN 15 individually, they are subsequently recombined.

In some embodiments, one or more filters may be applied to the region of interest. For example, one or more wavelengths of LED light may be filtered out. The LED may be shone across the entire region of interest and surrounding surfaces or portions thereof. Additionally, or alternatively, temporal signals in non-skin regions may be further processed. For example, analyzing the eyebrows or the eye's sclera may identify changes strongly correlated with motion, but not necessarily correlated with the photplethysmogram. If the same periodic signal predicted as the pulse is found on non-skin surfaces, it may indicate a non-real subject or attempted security breach.

Although illustrated as a single system, the functionality of system 100 may be implemented as a distributed system. While system 100 determines heart rate, other distributed configurations track changes to the subject's eye gaze, eye blink rate, pupil diameter, speech, face temperature, respiration rate, and micro-expressions, for example. Further, the functionality disclosed herein may be implemented on separate servers or devices that may be coupled together over a network, such as a security kiosk coupled to a backend server. Further, one or more components of system 100 may not be included. For example, system 100 may be a smartphone or tablet device that includes a processor, memory, and a display, but may not include one or more of the other components shown in FIG. 1. In another example, system 100 may include virtual or augmented reality glasses. The embodiments may be implemented using a variety of processing and memory storage devices. For example, a CPU and/or GPU may be used in the processing system to decrease the runtime and calculate the pulse in near real-time. System 100 may be part of a larger system. Therefore, system 100 may include one or more additional functional modules.

One or more datasets may be used to support analysis of video and pulse data for facial features including pulse, gaze, eye movement, blink rate, pupillometry, face temperature, and micro-expressions, for example. The dataset(s) may include high resolution RGB, near infrared (NIR), and thermal frames from face videos, along with cardiac pulse, blood oxygenation, audio, and liveness-oriented data.

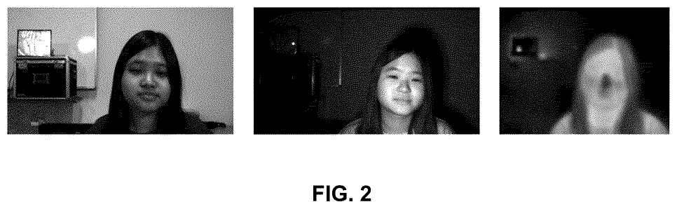

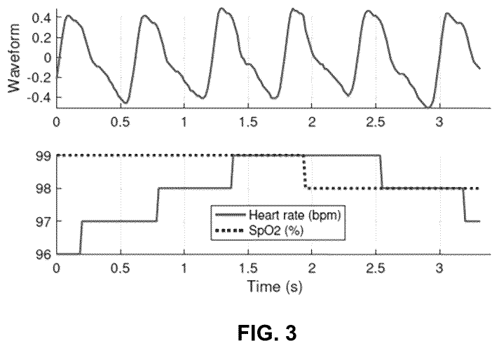

Detection of facial movements requires high spatial and temporal resolution. FIG. 2 illustrates the analyzing of images collected in different spectra. FIG. 2 shows sample images from the RGB, near infrared, and thermal cameras (left to right), and can be used to identify facial cues associated with liveness in a video stream. Additionally, changes observed in the cardiac pulse rate as in FIG. 3 may further indicate a subject's liveness in a video stream. Speech dynamics such as tone changes provide another mode for detecting liveness.

For example, the sensing apparatus may include (i) a DFK 33UX290 RGB camera from the Imaging Source (TIS) operating at 90 FPS with a resolution of 1920×1080 px; (ii) A DMK 33UX290 monochrome camera from TIS with a bandpass filter to capture near-infrared images (730 to 1100 nm) at 90 FPS and 1920×1080 px; (iii) a FLIR C2 compact thermal camera that yielded 80×60 px images at 9 FPS; and (iv) a Jabra SPEAK 410 omni-directional microphone recording audio of a subject at 44.1 kHz with 16-bit audio measurements. The sensors can be time-synchronized using visible and audible artifacts generated by an Arduino-controlled device.

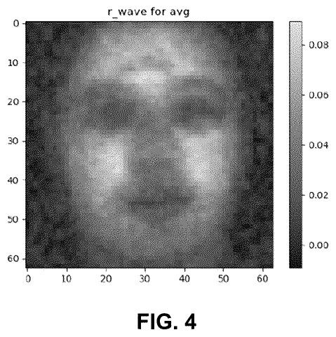

In the various embodiments, the inventors identified which regions of the face produce the best rPPG results. FIG. 4 illustrates the correlation between inferred and ground truth rPPG signals at each facial region. The facial cheeks and forehead give a rPPG signal that is more correlated with the ground truth than other parts of the face. The heatmap of FIG. 4 was generated by performing an evaluation using (for each subject) a 2×2 pixel region from every location across the 64×64 pixel video. These 632 regions were then averaged across subjects, and each region corresponds to a single pixel in the heatmap. From the image, it is understood that the facial cheeks and forehead produce a better rPPG wave than other facial skin, which is likely since those regions are more highly vascularized than other parts of the face.

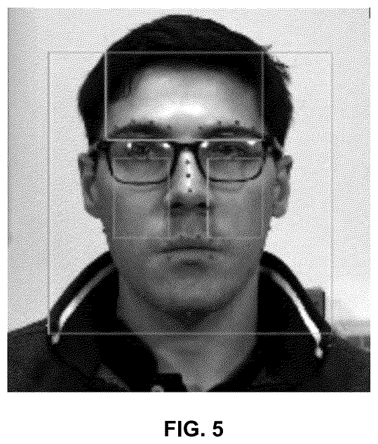

In the various embodiments, performance is improved by focusing it on regions with a stronger signal (i.e., the forehead and facial cheeks). The facial region can be divided into the three regions or regions of interest (e.g., forehead, right facial cheek, left facial cheek) as shown in FIG. 5. Using models trained over the full face, an rPPG was inferred wave over these regions. The forehead obtained the most accurate results of the subregions, although even when the three regions are combined, performance utilizing the full frame still outperforms these more focused regions.

Pupil detection involves eye region selection, and estimation of the pupil and iris radii. For selecting the eye region, OpenFace was utilized to detect 68 facial landmarks (e.g., utilizing the same detections as in pulse detection) and utilized the points around the eyelid to define an eye bounding box. The bounding box can be configured to have a 4:3 aspect ratio by lengthening the shorter side (which is usually the vertical side).

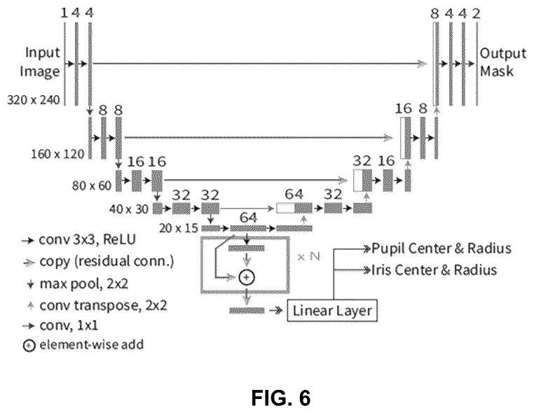

To detect the pupil and iris radii, a modified CC-Net architecture is used. In particular, the encodings from the CC-Net are used to configure a CNN regressor to detect circles fitting the iris and pupil as illustrated in FIG. 6. For the pupil and iris circle parameters, boundary points were traced for the pupil and iris in the masks and fit circles into these points using random sample consensus (RANSAC). Then, the modified CC-Net architecture was configured to predict both the mask, and the pupil and iris circle parameters.

On or more modalities can be used for liveness detection including pulse, gaze, eye movement (e.g., Saccadic), blink rate, pupillometry, face temperature, and micro-expressions, for example. A combination selected from rPPG, pupillometry, and thermal data is effective for liveness detection. As a standalone feature, rPPG is effective.

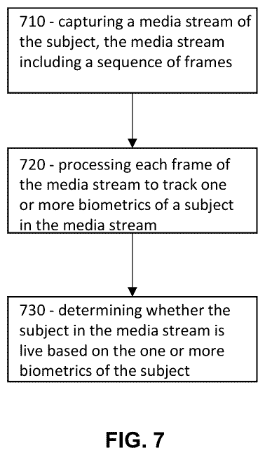

FIG. 7 illustrates a computer-implemented method for liveness detection.

At 710, the method captures a media stream of the subject, the media stream including a sequence of frames. The video stream may include one or more of a visible-light video stream, a near-infrared video stream, and a thermal video stream of a subject. In some instances, the method can combine at least two of the visible-light video streams, the near-infrared video stream, and/or the thermal video stream into a fused video stream to be processed. The visible-light video stream, the near-infrared video stream, and/or the thermal video stream are combined according to a synchronization device and/or one or more video/media analysis techniques.

Next, at 720, the method processes each frame of the media stream to track one or more biometrics. Additionally, or alternatively, the method processes each frame of the media stream to track changes in the one or more biometrics. For example, the biometrics (or changes thereto) may include two or more of pulse rate, eye gaze, eye blink rate, pupil diameter, face temperature, speech, respiration rate, and micro-expressions.

In some embodiments, pulse rates of different body parts (e.g., hand and forehead) can be compared to determine liveness. In this example, the pulse rates of the respective body parts should match, and may include an expected time offset (e.g., 70 to 80 ms).

Lastly, the method determines whether the subject in the media stream is live (i.e., not an attack or DeepFake) based upon the one or more biometrics or changes thereto. For example, changes to the subject's pulse, eye gaze, eye blink rate, pupil diameter, speech, face temperature, respiration rate, and micro-expressions are used to determine liveness, at 730.

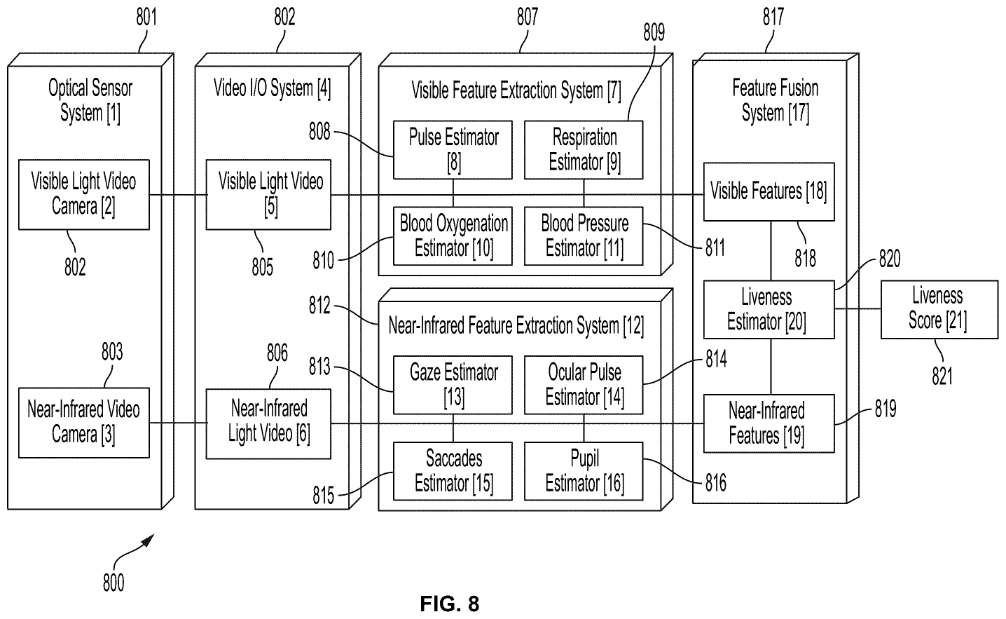

FIG. 8 illustrates another system for pulse waveform estimation and liveness detection. As the example embodiment illustrated in FIG. 8 includes many of the elements of FIG. 1, a complete description may be found in connection with or in combination with FIG. 1, and differences will be described in connection with FIG. 8. FIG. 8 illustrates a system 800 that includes optical sensor system 801, video 1/O system 804, visible feature extraction system 807, feature fusion system 817, and liveness estimator 820.

In the illustrated example embodiment, optical sensor system 801 may include a recording system with visible light camera 802 and near-infrared light camera 803. Other sensor types also may be used.

Video I/O system 804 receives one or more raw video streams from the sensors at 801 and stores the video streams or other sensor steams in memory and in a digital format. For example, visible light video 805 and near-infrared video 806 may be stored in memory in a digital format.

Visible feature extraction system 807 is configured to process features extracted from the media stream (e.g., visible light video 805). Pulse estimator 808 can be configured to execute rPPG. During each heartbeat, the volume of blood in capillaries changes, which changes the amount of light (red or infrared) absorbed in the subject's tissue. Pulse estimator 808 measures the fluctuation and generates waveform to calculate heart rate. Pulse estimator 808 can be applied on visible skin of one or more body parts, including but not limited to, faces, hands, palms, arms, etc. The frequency should remain constant across different surfaces of the skin, and is used as an indicator of liveness. The pulse rates of the respective body parts should match, and may include an expected time offset (e.g., 70-80 ms) between body parts.

Respirator estimator 809 is configured to estimate the respiration rate of a subject in a video stream. Inhalation and exhalation cause the lungs to physically inflate and deflate, which causes a rising and lowering of the abdomen and upper chest. These small periodic movements can be detected via sparse or dense tracking of points on the subject's body. Alternatively, if the subject's breathing is audible, the respiration rate can be determined using an audio stream.

Blood oxygen estimator 810 is configured to estimate blood oxygenation of a subject in a video stream. The arterial blood oxygenation describes the proportion of hemoglobin-oxygen binding sites bound with oxygen. Oxyhemoglobin (i.e., presence of oxygen) and deoxyhemoglobin (i.e., absence of oxygen) have different absorption spectra, which allows for its optical estimation. Blood oxygenation for healthy individuals is typically greater than 94%. The various attacks exhibit anomalous blood oxygenation levels.

Blood pressure estimator 811 is configured to estimate blood pressure of a subject in a video stream. The blood pressure estimator 811 calculates the systolic and diastolic blood pressures. It operates on any combination of the shape of the pulse waveform, the difference in waveform timing between different parts of the body, and the difference in waveform features between different parts of the body. The estimated blood pressure is either absolute blood pressure or an estimate of blood pressure relative to the initial reading.

Near-infrared feature extraction system 812 includes one or more systems for processing features extracted from the visible light video and/or near-infrared light video, such as gaze estimator 813, ocular pulse estimator 814, saccades estimator 815, and pupil estimator 816.

Gaze estimator 813 is configured to track the gaze of a subject in a video stream. For example, the gaze estimator 813 calculates the angle of the subject's gaze. It operates on a facial video steam and predicts the gaze angle, reported as a unit vector with components in the X, Y, and Z dimensions. Data postprocessing may be applied which consist of denoising techniques.

Ocular pulse estimator 814 is configured to estimate the pulse using the eyes of a subject in a video stream. The optical absorption of hemoglobin in the near-infrared spectrum results in an observable periodic signal as the blood volume changes in the periocular region. Additionally, small vertical movements occur as a result of the ballistic force from the downward ejection of blood from the aorta. This can be visibly estimated from a video stra, by tracking periodic movements of a dense or sparse set of points.

Saccades estimator 815 is configured to calculate the timing and properties relating to eye saccades. For example, it can be configured to operate on gaze estimates obtained by the gaze estimator 813, and searches for jumps in gaze angle. Eye saccade estimator 815 reports the time at which each saccade occurs, the maximum angular velocity, the start angle, the end angle, and/or the duration.

Pupil estimator 816 is configured to track the iris, its expansions and contractions, as the subject's pupil radius varies based on the amount of light entering the eye. Pupil estimator 816 fits a circle or ellipse to the pupil and tracks the dynamics over time. Recent DeepFake detectors have shown irregularities in the specular reflections of the pupil, and other deformities can be indicators of attack.

Feature fusion system 817 is configured to combine media steams from a plurality of sensors. For example, visible and near-infrared media steams can be collected and combined, and provided to the liveness estimator 820. Visible features extractor 818 is configured to combine features from previous visible light estimators and visible light video 805. Near-infrared features extractor 819 is configured to combine features from previous near-infrared visible light estimators and near-infrared light video 806.

Liveness estimator 820 determines whether the subject in the media/video stream is live based on the presences of authentic biometric markers. It estimates estimates the likelihood of liveness of the subject in the video stream. For example, liveness estimator 820 estimates the liveness from the visible and near-infrared features and indicates a liveness score 821. The liveness score 821 can be a real value between 0 and 1 indicating the likelihood that the input video is an attack.

Accordingly, the example embodiments estimate several physiological signals (i.e., parameters) from media/video streams, which may somehow be altered or nonexistent in an attack sample. To build a robust liveness detection system, one or more features can be combined to detect anomalous input qualities. Video/media streams may be analyzed in a variety of ways. For example, video posted on social media may be analyzed to determine whether it is live video or a DeepFake. In another example, one or more media/video streams may be used to authenticate a subject at a checkpoint (e.g., a border checkpoint or kiosk, an entry gateway or kiosk). Here, one or more body parts may be used to verify liveness. In yet another example, non-live facial images may be filtered out of a closed-circuit television CCTV video steam.

It will be apparent to those skilled in the art that various modifications and variations can be made in the liveness detection of the present invention without departing from the spirit or scope of the invention. Thus, it is intended that the present invention cover the modifications and variations of this invention provided they come within the scope of the appended claims and their equivalents.

What is claimed is:

1. A computer-implemented method for detecting liveness of a subject from a media stream, the computer-implemented method comprising:
capturing a media stream of the subject, the media stream including a sequence of frames;
processing each frame of the media stream to track one or more biometrics of the subject; and
determining whether the subject in the media stream is live based on the one or more biometrics detected in the media steam.

2. The computer-implemented method according to claim 1, wherein the media stream includes one or more of a visible-light video stream, a near-infrared video stream, a longwave-infrared video stream, a thermal video stream, and an audio stream of the subject.

3. The computer-implemented method according to claim 1, wherein the one or more biometrics includes two or more of pulse rate, eye gaze, eye blink rate, pupil diameter, face temperature, speech, respiration rate, and micro-expressions.

4. The computer-implemented method according to claim 1, wherein the one or more biometrics includes pulse rate and respiration rate.

5. The computer-implemented method according to claim 1, further comprising cropping each frame of the media stream to encapsulate a region of interest that includes one or more of a face, facial cheek, forehead, eye, eye pupil, chest or hand.

6. The computer-implemented method according to claim 5, wherein the region of interest includes two or more body parts.

7. The computer-implemented method according to claim 1, further comprising:
combining at least two of a visible-light video stream, a near-infrared video stream, and a thermal video stream into a fused video stream.

8. The computer-implemented method according to claim 7, wherein the visible-light video stream, the near-infrared video stream, and/or the thermal video stream are combined according to a synchronization device.

9. A system for detecting liveness of a subject from a media stream, the system comprising:
a processor; and
a memory storing one or more programs for execution by the processor, the one or more programs including instructions for:
capturing a media stream of the subject, the media stream including a sequence of frames;
processing each frame of the media stream to track one or more biometrics of the subject; and
determining whether the subject in the media stream is live based on the one or biometrics detected in the media steam.

10. The system according to claim 9, wherein the media stream includes one or more of a visible-light video stream, a near-infrared video stream, a longwave-infrared video stream, a thermal video stream, and an audio stream of the subject.

11. The system according to claim 9, wherein the one or more biometrics includes two or more of pulse rate, eye gaze, eye blink rate, pupil diameter, face temperature, speech, respiration rate, and micro-expressions.

12. The system according to claim 9, wherein the one or more biometrics includes pulse rate and respiration rate.

13. The system according to claim 9, further comprising cropping each frame of the media stream to encapsulate a region of interest that includes one or more of a face, facial cheek, forehead, eye, eye pupil, chest or hand.

14. The system according to claim 13, wherein the region of interest includes two or more body parts.

15. The system according to claim 9, further comprising:
combining at least two of a visible-light video stream, a near-infrared video stream, and a thermal video stream into a fused video stream.

16. The system according to claim 15, wherein the visible-light video stream, the near-infrared video stream, and/or the thermal video stream are combined according to a synchronization device.
